(19) United States
(12) Patent Application Publication
(10) Pub. No.: US 2010/0253205 A1
(43) Pub. Date: Oct. 7, 2010

(54) ELECTRIC LAMP HAVING AN OUTER BULB, A STEM AND AN INTEGRATED LAMP

(75) Inventors: Roland Stark, Wellheim (DE); Ivan Valent, Nové Zámky (SK)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/671,209

(22) PCT Filed: Jul. 16, 2008
(86) PCT No.: PCT/EP08/59304

§ 371 Date: Jan. 29, 2010

(30) Foreign Application Priority Data
Jul. 30, 2007 (DE) 10 2007 035 593.0

(51) Int. Cl. H01K 1/42

(52) U.S. Cl. 313/318.1

(57) ABSTRACT

An electric lamp is provided with a base at one end, having an outer bulb supported in a base, and at least one integral lamp, held inside the outer bulb by means of a mounting clip, the mounting clip being fixed on a stem, and the stem having a lower region and an upper region, and the cross-sectional area of the upper region being smaller than the cross-sectional area of the lower region, wherein the mounting clip is fixed on the upper region of the stem.

### TECHNICAL FIELD

The invention relates to an electric lamp with a base at one end, including an outer bulb supported in a base, and at least one integrated lamp, preferably a high voltage halogen lamp, held inside the outer bulb by means of a mounting clip, the mounting clip being fixed on a stem, and the stem having a lower, preferably cylindrical region and an upper region, and the cross-sectional area of the upper region being smaller than the cross-sectional area of the lower region.

### PRIOR ART

As a result of their long life and pleasant light quality, halogen incandescent lamps are increasingly preferred to conventional incandescent lamps. In order to make it possible to replace existing incandescent lamps with halogen incandescent lamps as simply as possible and at the same time to maintain the visual appearance of a conventional incandescent lamp for esthetic or functional reasons, lamps are often used in which the outer contour and therefore in particular the outer bulb and the base correspond to a conventional incandescent lamp, while a halogen incandescent lamp is arranged as an integral lamp within the outer bulb. Such lamps are produced and marketed, for example, by OSRAM GmbH under the designation “HALOLUX® CLASSIC”.

In order to bring the outward appearance and the luminous properties of such a lamp close to those of a conventional incandescent lamp, the incandescent wire of the integral lamp needs to be arranged approximately at the same point as the incandescent wire of a comparable conventional incandescent lamp. For this purpose, the substantially more compact halogen lamp needs to be positioned in the outer bulb by means of a holder.

A technology used in the abovementioned “HALOLUX® CLASSIC” lamps for positioning the integral lamp consists in providing a vitreous stem, which is sealed into the outer bulb. A frame manufactured from metal, by means of which the halogen integral lamp is in turn held, is sealed into the stem. Furthermore, sealed into the stem are supply leads to which the supply leads of the integral lamp are welded. This design requires, in order to pass the supply leads through the vitreous stem, a three-part design of the supply leads, and is generally very complex as a result of the combination of metallic and vitreous components.

DE 10 2005 051 076 discloses a lamp mount for the integral lamp, which essentially includes a cylindrical metallic mounting clip, into which the integral lamp is inserted and which is pushed onto a vitreous foot and is fixed in its lower, cylindrical region via a holding knob before the vitreous foot is fused with the outer bulb. However, because of its size, the mounting clip constitutes a very prominent component and is shaped in a very complex fashion.

### SUMMARY OF THE INVENTION

It is therefore the object of the invention to provide an electric lamp with a base at one end and in accordance with the preamble of claim 1 that is robust and can be produced easily.

This object is achieved according to the invention by virtue of the fact that the holding clip is fixed on the upper region of the stem. Consequently, the holding clip can be designed with smaller dimensions. Firstly, the holding clip becomes shorter, since it need no longer reach to the lower region of the stem and, secondly the dimensions are reduced in the radial direction, since a smaller mounting clip can be used for fixing on the upper region of the stem, which has a smaller cross section than the lower region. Owing to the reduced dimensions, the mounting clip is less prominent, and the lamp invokes the impression of a conventional incandescent lamp. Raw materials are saved, and the production process of the lamp can be simplified. In this case, the region of the stem facing the integral lamp and having a reduced cross-sectional area is to be regarded as upper region. This will preferably include the upper half, in particular the upper third of the stem.

It is advantageous when the upper region of the stem has at least two parallel sections extending in an axial direction. These can be both plane parallel surfaces and lines perpendicular to a cylindrical, oval or optionally polygonal cross section. The parallel sections enable the mounting clip to be guided effectively and held securely on the stem both when the lamp is being produced and in the finished state. Furthermore, parallel sections can be produced easily.

The fact that the upper region of the stem has a rectangular cross section means that a simple geometry is prescribed on which a mounting clip of less complex design can be effectively held. Since a rectangular cross section is constructed in principle from two plane parallel surface pairs, it can be easily produced by means of two pinching processes.

In a further advantageous design of the invention, the upper region of the stem has a cylindrical cross section. Cylindrical cross sections can also be easily produced and enable the mounting clip to be fastened easily.

It is likewise advantageous when the upper region of the stem has at least one groove in an axial direction. A groove enables effective guidance in a linear direction and secure holding of the mounting clip on the stem both during production of the lamp and in the finished state. Thus, the mounting clip can also be easily secured against rotation in the case of a cylindrical stem.

It is particularly advantageous when the mounting clip has at least one spring element. It is easily possible by means of spring elements to attain a force-closed connection that is expediently to be produced both between the mounting clip and the stem, and between the integral lamp and the mounting clip. The spring effect in this case further permits the equalization of dimensional tolerances. Even in the case of self-closed connections, it is advantageously possible to use a spring element, for example by being able to press latching lugs into depressions.

Furthermore, it is expedient when the mounting clip has in a lower region a cutout whose shape corresponds approximately to the shape of the cross-sectional area of the upper region of the stem. Exact fitting of the cutout on the upper region of the stem is thereby attained, and the mounting clip is therefore placed with particular accuracy and security.

In an advantageous embodiment the mounting clip in the lower region and/or the cutout arranged in the lower region has a rectangular cross section. Such a cross section is easy to produce and is an optimum fit with a stem whose upper region likewise has a rectangular cross section.

It is advantageous when the mounting clip has in an upper region at least two oppositely arranged spring lugs for holding the base of the integral lamp. As a result, the integral lamp can be held securely and dimensional tolerances of the components involved are equalized.

It is particularly advantageous when the integral lamp has a double T-shaped base, and the inner edges of the flanges of the base bear against the outer edges of the spring lugs of the mounting clip. Secure guidance of the integral lamp is thereby attained during mounting, and lateral displacements or tiltings of the integral lamp in relation to the mounting clip are prevented.

It is likewise particularly advantageous when the width of the spring lugs for holding the base of the integral lamp corresponds approximately to the width of the rod of the base of the integral lamp. This ensures in a simple way that the inner edges of the flanges of the base bear against the outer edges of the spring lugs of the mounting clip.

At least one spring lug for holding the base of the integral lamp advantageously has at the upper end at least one projection, in particular a knob and/or a bead. Both a simple guidance of the base into the mounting clip and effective holding there are thereby enabled. Given that the projection engages in a depression in the base or is guided away via a projection on the base, it is possible to attain a self-closed connection.

It is expedient when the mounting clip has in the lower region on at least one edge a cutout, and at least one holding lug, preferably produced by bending over at the edge, is arranged on a wall adjacent to the cutout, preferably on the wall arranged on the longitudinal side of the rectangular lower region. Such a mounting clip can easily be produced by stamping and bending over at the edge, and good guidance and holding of the mounting clip on the stem is attained.

A particularly good guidance and holding of the mounting clip is achieved by virtue of the fact that the mounting clip in the lower region has on at least two diagonally opposite edges a cutout with a holding lug in accordance with the preceding claim.

It is expedient when the mounting clip has at least one cutout between the upper region and the lower region. The supply leads of the integral lamp are therefore accessible and can be connected to the supply leads embedded in the stem.

In a particularly advantageous design of the invention, the mounting clip is of fork-shaped design in the lower region.

What are to be regarded as fork-shaped in the context of this application are, in particular, designs that have at least two prongs, that is to say two projections, whose length is at least as large as their width, and between which there is arranged a cutout that corresponds approximately to the length of the projections, the thickness of the mounting clip being less than the length and/or width of the mounting clip, preferably at most half thereof. A mounting clip of such design can be produced particularly easily, for example by stamping. The fork-shaped region can be used in a simple way to fasten the mounting clip on the stem by virtue of the fact that the upper region of the stem, or a suitable part thereof, is introduced into the cutout between the fork prongs.

It is advantageous, furthermore, when the mounting clip is of fork-shaped design in the upper region. The integral lamp can in this way be held with its base in a particularly simple fashion in the mounting clip which, in addition, can be produced particularly easily, for example by stamping.

In a particularly advantageous design of the invention, the mounting clip is of fork-shaped design in the upper region and in the lower region. Consequently, the mounting clip can be formed particularly easily, for example as a stamping, since the production has no need for any bending over at an edge, bending operations or connecting processes.

It is advantageous when at least one prong of the lower fork-shaped region of the mounting clip engages in at least one groove of the upper region of the stem. Consequently, the mounting clip is just as secured against rotation about the longitudinal axis as against lateral tilting or displacement.

In a further advantageous design of the invention, the fork-shaped lower region of the mounting clip has at least three prongs. The middle prong can be arranged, for example, in a slightly crimped or bent fashion in order to hold the stem between it and the outer prongs.

It is likewise advantageous when at least one prong of the fork-shaped lower region of the mounting clip engages in a depression arranged on the end face of the stem, in particular in an exhaust tube. Exhaust tubes are frequently already present in the case of stems, and so no additional outlay in production results for the stem. The mounting clip is held in a particularly simple way on the stem and secured on all sides against displacements in a radial direction.

It is advantageous, furthermore, when at least one prong of at least one fork-shaped region is designed as a spring element. Consequently, this can be used particularly effectively as a holding element with the above-described advantages of a spring element.

### BRIEF DESCRIPTION OF THE DRAWINGS

The aim below is to explain the invention with the aid of three exemplary embodiments. Identical and functionally identical components are marked with identical reference numerals. In the figures:

FIG. 1 shows a first exemplary embodiment of an inventive lamp,

FIG. 2 shows an inventive lamp in accordance with the first exemplary embodiment, in a detailed side view,

FIG. 3 shows a second exemplary embodiment of an inventive lamp in a side view,

FIG. 4 shows an inventive lamp in accordance with the second exemplary embodiment, in a detailed side view,

FIG. 5 shows an inventive lamp in accordance with the second exemplary embodiment, in a sectional view illustration,

FIG. 6 shows a third exemplary embodiment of an inventive lamp, in perspective view,

FIG. 7 shows an inventive lamp in accordance with the third exemplary embodiment, in a detailed side view,

FIG. 8 shows a mounting clip in accordance with the third exemplary embodiment, in perspective,

FIG. 9 shows an inventive lamp in accordance with the third exemplary embodiment, in a detailed view, and

FIG. 10 shows an inventive lamp in accordance with the third exemplary embodiment, in a detailed side view.

### PREFERRED DESIGN OF THE INVENTION

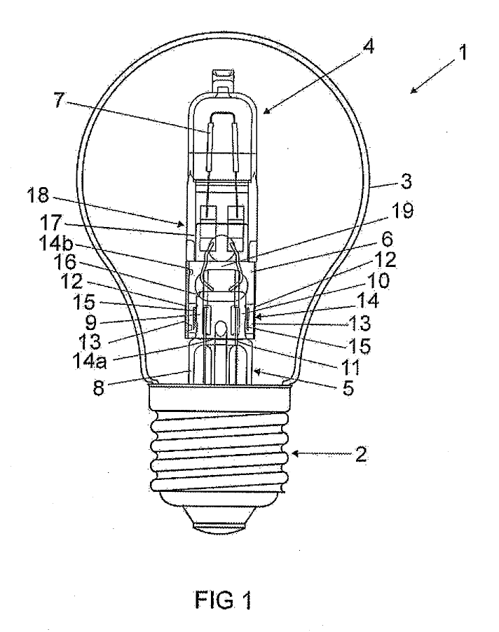

FIG. 1 shows an inventive lamp 1 in a side view. An outer bulb 3 of the type A55 is held in a base 2 of the customary type E27. By means of a mounting clip 6 fastened on a vitreous stem 5, an integral lamp 4 is arranged within the outer bulb 3 such that an incandescent wire 7 of the integral lamp 4 is located approximately at the point within the outer bulb 3 at which the incandescent wire is likewise arranged in a conventional incandescent lamp. The stem 5 is fused with the outer bulb 3. The integral lamp 4 is designed as a so-called high voltage halogen lamp using pinching knob technology, and is known as such from the prior art.

In a lower region 8, the stem 5 has a cylindrical cross section that tapers to an upper region 9 and merges into a rectangular cross section. In the case of a vitreous stem 5, the rectangular region 9 can easily be achieved by twofold pinching at an angle of 90°. Pushed onto the upper region 9 of the stem 5 is the mounting clip 6, which is produced from a metal sheet stamped and then bent over at the edge in rectangular fashion. The mounting clip 6 is likewise designed with a rectangular shape in its lower region 10 such that the upper region 9 of the stem 5 is held in a rectangular opening 11 in the lower region 10 of the mounting clip 6. Respectively arranged in this case at the edges 12, running in an axial direction, of the lower region 10 of the mounting clip 6 are cutouts 13 in the case of which a holding lug 15 is respectively arranged on the longitudinal side 14a of the wall 14 of the mounting clip 6. These holding lugs 15 bear in slightly resilient fashion against the upper region 9 of the stem 5, and thus ensure effective fixing. The introduction is facilitated by the rounding of the upper edge 16 of the stem 5. The integral lamp is, in turn, held in the mounting clip 6 by means of two spring lugs 17 that are arranged in the upper region 18 of the mounting clip 6 on the longitudinal sides 19.

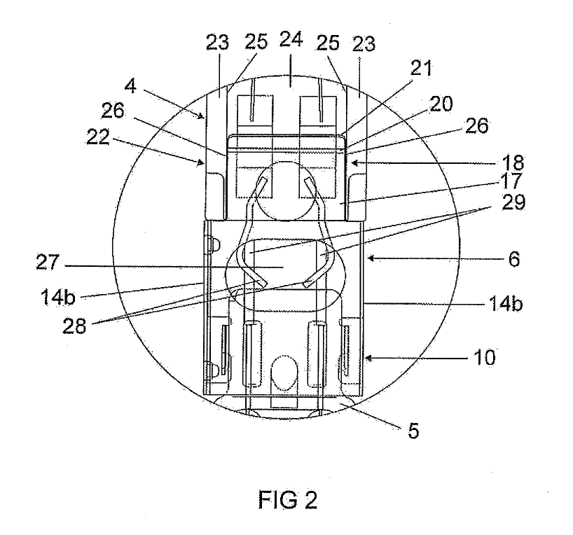

As may be seen from FIG. 2, the spring lugs 17 have at the upper end a bead 20 extending over the entire width. The bead 20 on the one hand facilitates the introduction of the base 22 of the integral lamp 4 between the spring lugs 17 by means of its upper incline 21, and on the other hand ensures an effective hold. This is true, in particular, for integral lamps 4 whose base 22 has elevations in a transverse direction such that the bead can, as it were, latch in between two elevations or above the uppermost elevation, and the integral lamp 4 is therefore firmly fixed in the mounting clip 6. The integral lamp 4 is supported downward on the side walls 14b of the lower region 10 of the mounting clip 6.

The base 22 of the integral lamp 4 has a double T-shaped cross section with a rod 24 arranged between two flanges 23. The width of the spring lugs 17 corresponds to that of the rod 24, and so the inner edges 25 of the flanges 23 and the outer edges 26 of the spring lugs 17 bear against one another, the result being to achieve guidance of the integral lamp 4 during introduction into the mounting clip 6, and equally to achieve fixing of the integral lamp 4 against lateral displacements.

Furthermore, between the upper region 18 and the lower region 10 the mounting clip 6 has an opening 27 in which can be seen the supply leads 28 of the integral lamp 4 and the supply leads 29 embedded in the stem 5. The opening 27 enables access to the supply leads 28 of the integral lamp 4 and to the supply leads 29 embedded in the stem 5, in order to weld them to one another during the production of the lamp 1. This connection serves simultaneously for additionally fixing the integral lamp 4 in an axial direction.

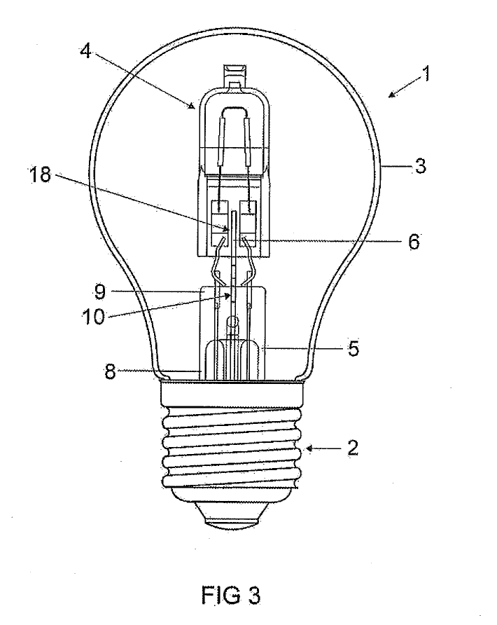

A second exemplary embodiment of an inventive lamp 1 is shown in a side view in FIG. 3. The principle of the design with base 2, outer bulb 3, stem 5 fused with the outer bulb 3, and integral lamp 4 corresponds to the lamp 1 shown in FIG. 1. By contrast with the first exemplary embodiment, however, here the mounting clip 6 is designed as a simple stamping made from stainless steel, and can therefore be produced particularly easily and cost-effectively, since complex shaping processes such as bending, bending over at an edge, welding or soldering are eliminated. The lower region 10 of the mounting clip 6 is held on the upper region 9 of the stem 5, while the upper region 18 of the mounting clip 6 holds the integral lamp 4. The integral lamp 4 is, in addition, secured on the mounting clip 6, particularly against tilting and displacement, by the connection between the supply leads 28 of the integral lamp 4 and the supply leads 29 sealed in the stem 5.

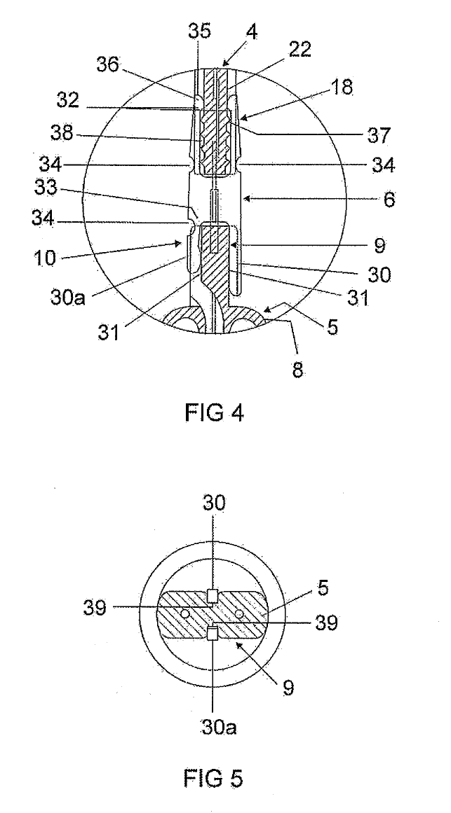

Owing to simple pinching perpendicular to the plane of the drawing, the upper region 9 of the stem has a smaller cross-sectional area than the lower part 8, something which becomes clear particularly in FIG. 4, which shows a detailed view, rotated about the lamp longitudinal axis by 90°, of the mounting clip 6. Furthermore, it is well in evidence in FIG. 4 that the mounting clip 6 is of fork-shaped design in its lower region 10 toward the stem 5, and in its upper region toward the integral lamp 4. The result is a particularly simple design of the mounting clip 6, as also of the stem 5.

Two lower fork prongs 30, 30a engage over the upper region 9 of the stem 5 which—by contrast with the previous exemplary embodiment—need not necessarily be of rectangular design. There is a need only to design the bearing surfaces 31 for the fork prongs 30, 30a in an approximately parallel fashion.

Furthermore, two upper fork prongs 32 and one fork prong 30a in the lower region 10 of the mounting clip 6 respectively have on the fork foot 33 a cutout 34 which has the effect that the fork prongs 30a, 32 bear resiliently against the stem 5 or the integral lamp 4, and therefore act as spring lugs. The resilient prongs 30a, 32 are, furthermore, respectively provided at the fork tip 35 with a projection 36 that has the purpose of holding and more easily introducing the components in the mounting clip 6 that are held by the prongs 30, 32. If, as in this exemplary embodiment, the base 22 of the integral lamp 4 has a corrugation 37 owing to the pinching, the projections 36 of the prongs 32 engage in the depressions 38 of the corrugation 37 such that self-closed fixing in an axial direction is attained.

In order to prevent tilting or lateral displacement of the mounting clip 6 on the stem 5, in the upper region 9 the stem 5 is, as may be seen from FIG. 5, which illustrates a section perpendicular to the lamp longitudinal axis, provided on both sides with in each case one groove 39 that runs in an axial direction and in which one fork prong 30, 30a each is guided. In addition, the grooves 39 provided on both sides particularly reliably prevent the mounting clip 6 from rotating about its longitudinal axis.

Of course, other embodiments are also conceivable, for example with only one groove 39 in the stem 5, or with another configuration of the mounting clip 6 and, in this case, particularly of the fork prongs 30, 32.

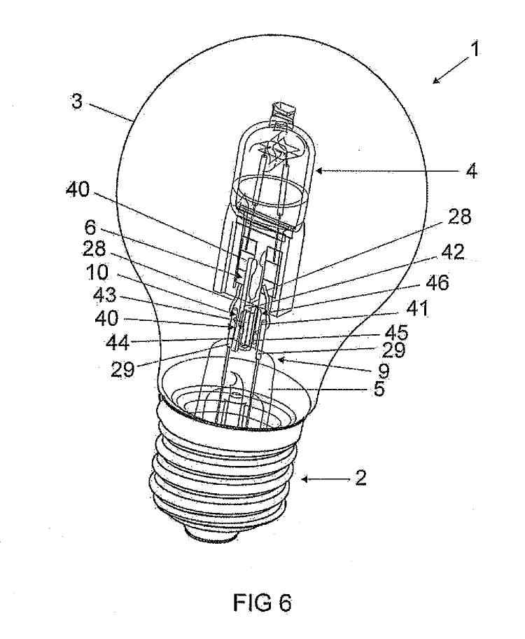

A further variant of an inventive lamp is shown in FIG. 6. The principle of the design with base 2, outer bulb 3, stem 5 fused with the outer bulb 3, integral lamp 4 and fork-shaped mounting clip 6 corresponds to the lamp 1, shown in FIG. 3, in accordance with the second exemplary embodiment. Here, however, by contrast with the second exemplary embodiment, the mounting clip 6 is designed in the lower region 10 as a three-pronged fork 40. Here, by contrast with the previous exemplary embodiments, the upper region 9 of the stem 5 is formed by a cylindrical exhaust tube 41. The middle prong 43 of the three-pronged fork 40 is positioned in an opening 42 in the exhaust tube 41, while the outer prongs 44, 45 are guided downward along the outer wall 46 of the exhaust tube 41. In addition, the integral lamp 4 and the mounting clip 6 are secured, in particular, against axial movements by the connection between the supply leads 28 of the integral lamp 4 and the supply leads 29 sealed in the stem 5.

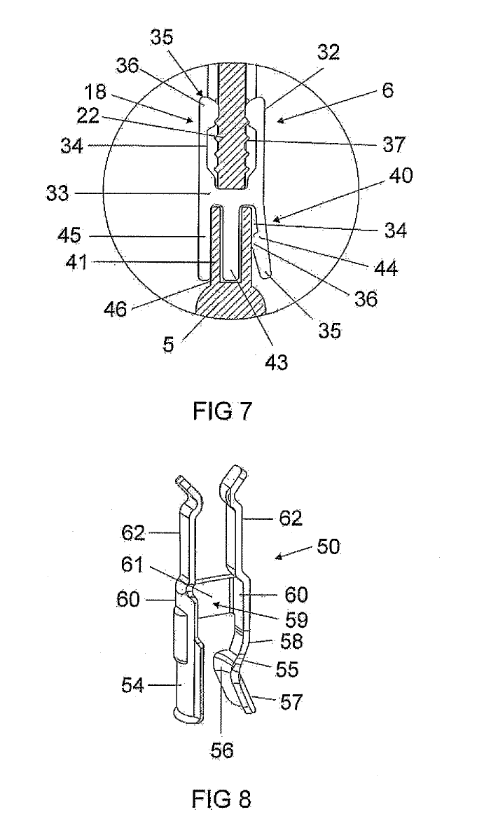

As may be seen from FIG. 7, which illustrates a detailed side view of the mounting clip 6, one prong 44 of the three-pronged fork 40 has on the fork foot 33 a cutout 34 that merges directly into a projection 36 as a result of which the opposite prong 45 bears resiliently against the exhaust tube 41. The prong 44 therefore acts as a spring lug. The projection 36 is gently beveled toward the fork tip 35 and thus, in addition to secure holding, also enables the mounting clip 6 to be more easily introduced into the exhaust tube 41. In the present exemplary embodiment, the middle prong 43 serves for additionally stabilizing the entire arrangement, in particular against lateral tilting. Furthermore, it is also possible to use the prong 45 to implement a rotation protection by virtue of the fact that, by way of example, said prong engages in a groove in the outer wall 46 of the exhaust tube 41. Another possibility for preventing rotation consists, for example, in that the exhaust tube 41 has an elliptical cross section.

In the upper region 18, the mounting clip 6 has two fork prongs that likewise act as spring lugs. To this end, there is provided above the fork foot 33 a cutout 34 that merges at the fork tip 35 into a projection 36. Here, as well, self-closed fixing in an axial direction is attained by the projections 36 in cooperation with the corrugation 37 of the pinched base 22 of the integral lamp 4.

Of course, other embodiments of the invention are also conceivable, in particular for the configuration of the mounting clip 6 and, hereby above all, in the upper region 18 in which the integral lamp 4 is held. Thus, in particular, the width of the spring lugs 17 can be varied between the embodiment of a fork prong 32 in accordance with the second and third exemplary embodiments, and the spring lug 17 in accordance with the first exemplary embodiment, which covers approximately the whole width of the base 22.

Instead of the outer bulb 3 with the designation A55, which is shown in the exemplary embodiments and is typical of a general service incandescent lamp, other bulb shapes, such as the types A60, R63, R80 or G95, for example, are, of course, also conceivable, as are also possible other base sizes, such as E14 or E40, for example, as well as other base types such as, for example, bayonet or plug bases instead of the type E27 screw base 2 shown.

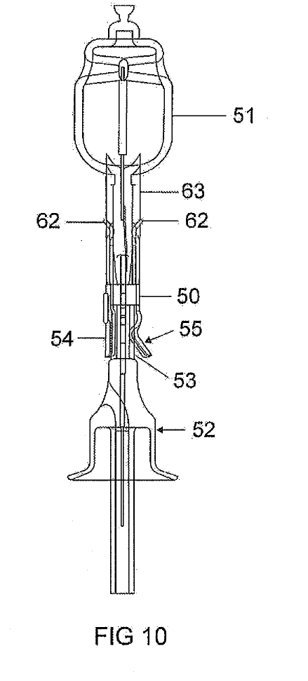

FIGS. 8 to 10 show a further exemplary embodiment of a mounting clip 50. For the purpose of fastening the integral lamp 51 stably on the stem 52, the mounting clip 50 is pushed onto a tubular upper region 53 of the stem. A projecting exhaust tube is particularly suitable as tubular upper region. A clip lug 54 rounded in a partial circle ensures axially stable fastening. It is preferably designed to be half round to quarter round. This upper region 53 lies concentrically in it. Lying opposite the clip lug 54 is a similarly configured spring part 55. In one section, it is also designed in a fashion rounded in a partial circle, preferably as a half shell, such that it can bear against the upper region 53. However, it is slightly inwardly arcuately corrugated so that only a base part 56 bears against the upper region 53 and two wing parts project therefrom. The first wing part 57 is a free end that serves as a threading aid while placing the mounting clip onto the upper region 53. The second wing part 58 is the connecting part from the base part to the rest of the mounting clip. Clip lug and spring part are interconnected at their upper ends via a connecting clasp 59 bent back in a U-shaped fashion.

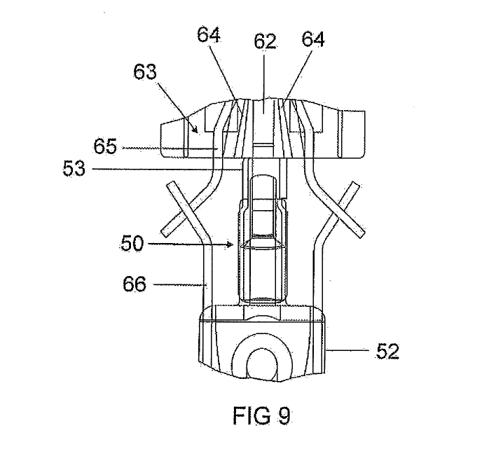

Consequently, it has two limbs 60 and a base part 61. Respectively attached at the top to the limbs 60 is a spring lug 62 that extends toward the integral lamp. Consequently, the pinch 63 of the integral lamp, which serves, as it were, as a glass base of the integral lamp, is held between the two spring lugs 62 in the manner of tweezers. The spring lugs are automatically centered when the integral lamp is joined on owing to obliquely positioned webs that taper upward from the lower edge of the pinch and whose minimum spacing is somewhat larger than the width of the spring lugs 62, or else owing to local bosses on the pinch. The integral lamp 51 is therefore also fixed axially. The supply leads 65 of the integral lamp are then welded with the feed lines 66 that project from the stem 52. This can be performed by laser welding or else by resistance welding. It is possible in this case for the purpose of additional fixing for the feed lines 66 and supply leads 65 preferably to be bent away obliquely outward, that is to say away from the lamp axis, although remaining essentially in the plane of the pinch. Feed line 66 and supply lead 65 therefore cross one another in an x-shaped fashion. If one supply lead is guided in front of, and the other, by comparison therewith, guided behind the feed line, the stability is raised still further, as illustrated in FIG. 9. A very cost-effective and stable fastening of the integral lamp in the outer bulb is achieved in this way.

1. An electric lamp with a base at one end, comprising an outer bulb supported in a base, and at least one integral lamp, held inside the outer bulb by means of a mounting clip, the mounting clip being fixed on a stem, and the stem having a lower region and an upper region, and the cross-sectional area of the upper region being smaller than the cross-sectional area of the lower region, wherein the mounting clip is fixed on the upper region of the stem.

2. The electric lamp with a base at one end as claimed in claim 1, wherein the upper region of the stem has at least two parallel sections extending in an axial direction.

3. The electric lamp with a base at one end as claimed in claim 2, wherein the upper region of the stem has a rectangular cross section.

4. The electric lamp with a base at one end as claimed in claim 1, wherein the upper region of the stem has a cylindrical cross section.

5. The electric lamp with a base at one end as claimed in claim 1, wherein the upper region of the stem has at least one groove in an axial direction.

6. The electric lamp with a base at one end as claimed in claim, wherein the mounting clip has at least one spring element.

7. The electric lamp with a base at one end as claimed in claim 1, wherein the mounting clip has in a lower region a cutout whose shape corresponds approximately to the shape of the cross-sectional area of the upper region of the stem.

8. The electric lamp with a base at one end as claimed in claim 1, wherein the mounting clip in at least one of the lower region and the cutout arranged in the lower region has a rectangular cross section.

9. The electric lamp with a base at one end as claimed in claim 1, wherein the mounting clip has in an upper region at least two oppositely arranged spring lugs for holding a base of the integral lamp.

10. The electric lamp with a base at one end as claimed in claim 1, wherein the integral lamp has a double T-shaped base, and the inner edges of the flanges of the base bear against the outer edges of the spring lugs of the mounting clip.

11. The electric lamp with a base at one end as claimed in claim 10, wherein the width of the spring lugs for holding the base of the integral lamp corresponds approximately to the width of the rod of the base of the integral lamp.

12. The electric lamp with a base at one end as claimed in claim 1, wherein at least one spring lug for holding the base of the integral lamp has at the upper end at least one projection.

13. The electric lamp with a base at one end as claimed in claim 1, wherein the mounting clip has in the lower region on at least one edge a cutout, and at least one holding lug is arranged on a wall adjacent to the cutout (13).

14. The electric lamp with a base at one end as claimed in claim 13, wherein the mounting clip in the lower region has on at least two diagonally opposite edges a cutout with the holding lug.

15. The electric lamp with a base at one end as claimed in claim 1, wherein the mounting clip has at least one cutout between the upper region and the lower region.

16. The electric lamp with a base at one end as claimed in claim 1, wherein the mounting clip is of fork-shaped design in the lower region.

17. The electric lamp with a base at one end as claimed in claim 1, wherein the mounting clip is of fork-shaped design in the upper region.

18. The electric lamp with a base at one end as claimed in claim 1, wherein the mounting clip is of fork-shaped design in the upper region and in the lower region.

19. The electric lamp with a base at one end as claimed in claim 16, wherein at least one prong of the lower fork-shaped region of the mounting clip engages in at least one groove of the upper region of the stem.

20. The electric lamp with a base at one end as claimed in claim 16, wherein the fork-shaped lower region of the mounting clip has at least three prongs.

21. The electric lamp with a base at one end as claimed in claim 16, wherein at least one prong of the fork-shaped lower region of the mounting clip engages in a depression arranged on the end face of the stem.

22. The electric lamp with a base at one end as claimed in claim 16, wherein at least one prong of at least one fork-shaped region is designed as a spring element.

23. The electric lamp with a base at one end as claimed in claim 4, wherein the lower region of the mounting clip has a clip lug that is rounded in a partial circle and is situated as a spring element opposite an arcuately inwardly curved spring lug.

24. The electric lamp with a base at one end as claimed in claim 1, wherein the at least one integral lamp is configured as a high voltage halogen lamp.

25. The electric lamp with a base at one end as claimed in claim 1, wherein the lower region is a cylindrical region.
